(19) United States
(12) Patent Application Publication
(10) Pub. No.: US 2020/0191358 A1
(43) Pub. Date: Jun. 18, 2020

(54) Elongated Lighting Apparatus

(71) Applicant: Aleddra Inc., Renton, WA (US)

(72) Inventors: Chia-Yiu Maa, Bellevue, WA (US); Yipin Cai, Huizhou (CN); Chun-Te Yu, Bellevue, WA (US)

(21) Appl. No.: 16/217,317

(22) Filed: Dec. 12, 2018

(51) Int. Cl. F21V 7/00; F21S 8/06; F21V 21/30; F21V 21/34; A61G 7/05

(52) U.S. Cl. CPC F21V 7/005; F21S 8/06; F21Y 2103/00; F21V 21/34; A61G 7/05; F21V 21/30

(57) ABSTRACT

An elongated lighting apparatus includes an elongated housing and one or more elongated light source. The elongated light sources are inside the housing. Each elongated light source is coupled with at least one elongated lens on the housing. There is a means mounted on the housing for adjusting the direction, or the beam angle, or both, of the light emitted out of the at least one elongated lens. The at least one elongated lens and the elongated housing may be coated with an anti-bacterial photocatalytic film that can be activated by visible light.

### BACKGROUND

### Technical Field

The present disclosure pertains to the field of lighting devices and, more specifically, proposes an elongated lighting apparatus.

### DESCRIPTION OF RELATED ART

The overbed lighting fixtures used above the patient bed in hospital are normally in elongated shape so that its light is wide enough to cover the entire width of the bed. The overbed light fixtures generally have multiple lighting modes for different lighting needs, such as reading light, ambient light, and examination light. With the reading light mode, the light of the overbed lighting fixture is shining downward so as to provide the patient on the bed enough light for general reading. With the ambient light mode, the light of the overbed lighting fixture may shine both upward and downward so as to provide enough light for the patient room. With the examination light mode, the overbed lighting fixture put out the highest light output level, and ideally, in the direction that may light up the entire patient bed so as to provide sufficient light for the healthcare professionals to examine the patient. Some overbed lighting fixtures may have a night light mode.

In order to support the multiple lighting modes, the overbed lightings may use multiple elongated light sources. To conserve energy and the number of lighting sources in the fixtures, one elongated light source may be used in multiple light mode. For example, one elongated light source may be used for both the ambient light mode and the examination light mode. However, for ambient lighting, the light of the overbed fixture is shining upward and downward, thus is not effectively providing sufficient forward light output that is needed for examination light. Even the lens of the overbed fixture is designed with an angle to direct the light away from the mounting wall of the fixture, it is difficult to redirect the light of the overbed fixture as needed in the direction where the patient is (in lying position or sitting position), and with a focused beam angle.

The present disclosure introduces an elongated lighting apparatus with an adjustable lens design to overcome the limitations of the overbed lighting fixtures.

### SUMMARY

In one aspect, the elongated lighting apparatus comprises an elongated housing and one or more elongated light sources, where the one or more elongated light sources are inside the elongated housing. Each elongated light source is coupled with at least one elongated lens on the housing. There is a mean on the housing for adjusting the direction, or the beam angle, or both, of the light coming out of at least one elongated lens. For example, this elongated lighting apparatus may have three elongated light sources inside its housing, each light source is coupled with one elongated lens, and one of the three lens can be adjusted in the direction, direction or the beam angle or both of the light coming out of it.

In some embodiments, the means for adjusting the direction of the light of at least one elongated lens is a rotating mechanism that rotates the lens in the direction perpendicular to the axis of the elongated lens. By adjusting this rotating mechanism, the light of the lens can thus shine upward, forward, downward, or any direction in-between. In some other embodiments, one such rotating mechanism is a rotating knob that rotates the lens in the direction perpendicular to the axis of the elongated lens.

In some embodiments, the means for adjusting the beam angle of the light of at least one elongated lens expands and contracts the beam angle in the direction perpendicular to the axis of the elongated lens. With an adjustable beam angle, the elongated lens can use a wide beam angle such as 120 degree for ambient lighting and a narrow beam angle such as 60 degree for examination lighting. With a narrower beam angle, the light of the lens may shine farther with a higher light level as compared with a broader beam angle.

In some embodiments, the means for adjusting the beam angle of the light of at least one elongated lens is the changing of the distance of the elongated lens to its corresponding elongated light source. When the lens is closer to the elongated light source it coupled with, the wider the beam angle. When the lens is away to the elongated light source it coupled with, the narrower the beam angle.

In some other embodiments, the means for adjusting the beam angle of the light of at least one elongated lens is an elongated shutter that changes the effective width of the lens in the direction perpendicular to the axis of the elongated lens. The inside surface of the shutter may be coated with reflective material such that the light can be reflected off the inside surface of the shutter, and the total light output coming out of the lens is not reduced as the bean angle becomes narrower.

In some embodiments, the exterior of the elongated lens or the exterior of the housing or both are coated with an anti-bacterial photocatalytic film. Since the overbed lighting fixture is immediately above the bed of a patient, the anti-bacterial photocatalytic film on the housing and the lens, when activated, could remove the bacteria and the viruses in the air, thus beneficial to the health of the patient.

In some embodiments, the anti-bacterial photocatalytic film is photocatalytic activated by the light of the elongated light sources. In some other embodiments, the anti-bacterial photocatalytic film is photocatalytic activated by ambient light with at least 95% of a spectral power distribution (SPD) in a visible light wavelength range greater than 400 nm. Most of the light sources for general lighting, such as incandescent bulbs, fluorescent bulbs, LED bulbs, generate at least 95% of a spectral power distribution (SPD) in a visible light wavelength range greater than 400 nm, and so it the sunlight. When the elongated lighting apparatus is turned on, the light coming out of the apparatus can activate the anti-photocatalytic film. But even when the elongated lighting apparatus is turned off, the ambient light, such as sunlight or other indoor light source, may still activate the anti-photocatalytic film, thus providing the anti-bacterial/anti-viral protection to the patient.

In some embodiments, a main active ingredient of the anti-bacterial photocatalytic film is titanium dioxide (TiO₂). In some other embodiments the main active ingredient is rhombus-shape anatase-type titanium dioxide (TiO₂). As shown in U.S. Pat. No. 9,522,384 by Liu L. et al, the rhombus-shape anatase-type titanium dioxide has a much higher volume density than the sphere-shape anatase-type titanium dioxide, thus it is more effective in the photocatalytic killing of bacteria and viruses.

In some embodiments, the anti-bacterial photocatalytic film may contain at least one other active metal ingredient such as but not limited to, silver, gold, copper, zinc, or nickel. These metals when embedded in the photocatalyst are known to enhance the photocatalytic activity with visible light. Some photocatalytic film may contain more than one type of metals for a better photocatalytic effectiveness.

The titanium dioxide is classified as a semiconducting photocatalyst. Recently technology breakthrough has demonstrated that noble metal nanoparticles such as gold (Au) and silver (Ag) can are a class of efficient photocatalysts working by mechanisms distinct from those of semiconducting photocatalysts (https://pubs.rsc.org/en/content/articlelanding/2013/gc/c3gc40450a #!divAbstract). The present disclosure is not limited to the use of semiconducting photocatalysts. In some embodiments, the main active ingredient of the anti-bacterial photocatalytic film is a noble metal nanoparticle comprising gold (Au) or sliver (Ag).

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily to scale, as some components may be shown to be out of proportion to size in actual implementation in order to clearly illustrate the concept of the present disclosure.

FIG. 1a schematically depicts a diagram of the exterior of an elongated lighting apparatus with LED light sources and a rotating knob.

FIG. 1b schematically depicts the interior of the elongated lighting apparatus.

FIG. 1c schematically depicts the cross section of the elongated lighting apparatus.

FIG. 2 schematically depicts a diagram of an elongated lighting apparatus with an adjustable beam angle through the changing of the distance of the elongated lens to the coupled elongated light source.

FIG. 3 schematically depicts a diagram of an elongated lighting apparatus with a shutter for adjusting the beam angle.

### DETAILED DESCRIPTION OF PREFERRED EMBODIMENTS

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the various concepts discussed herein may be suitably implemented in a variety of lighting apparatuses having different form factors.

### Example Implementations

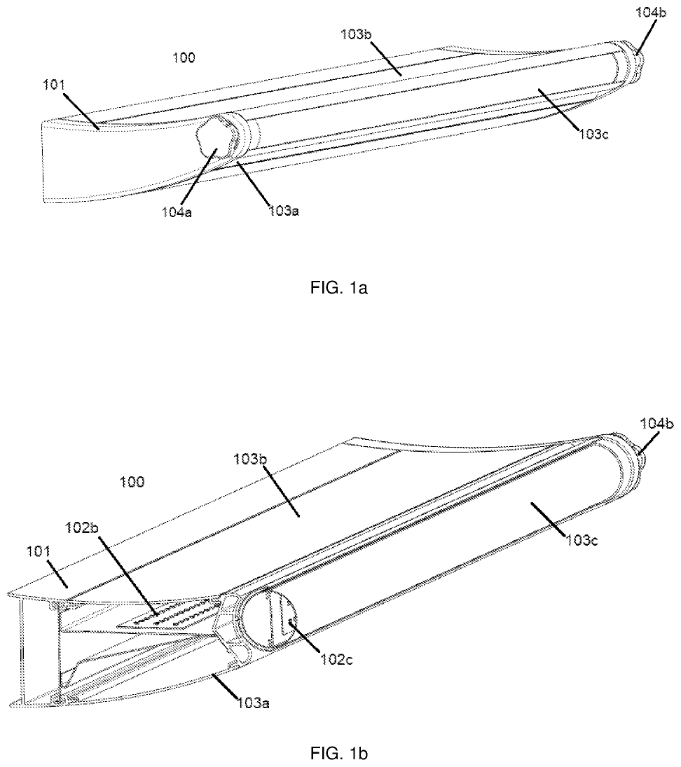

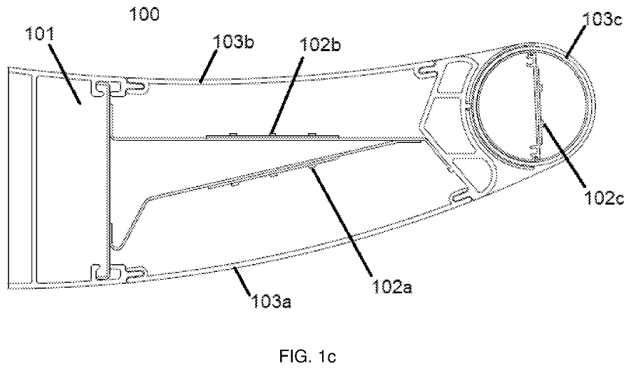

The FIG. 1a, 1b, 1c are an elongated lighting apparatus of the present disclosure in the form of an overbed lighting fixture, where FIG. 1a shows the exterior of the fixture, the FIG. 1b the interior of the fixture, and the FIG. 1c the cross-section view of the fixture. The fixture 100 has a housing 101, three elongated LED lighting sources 102a, 102b, 102c, and three elongated lens 103a, 103b, 103c. The overbed light is hung over the head of a patient bed. For reading light mode, the light source 102a is turned on and its light shines through the lens 103a. Notice that the light source 102a and the lens 103a are titled with an angle so that the light coming out from the lens 103a has a forward throw, thus provide adequate lighting coverage for the half of the bed closer to the fixture for reading application. For ambient light mode, the light source 102b is turned on and its light shines through the lens 103b toward the ceiling. The light source 102c may be used for the examination light mode. Its light shines through the lens 103c. The rotating knobs 104a, 104b are used to adjust the direction of the lens 103c. When in examination mode, either of the knobs 104a, 104b can be used to adjust the lighting direction of the lens 103c downward and toward the patient, thus providing sufficient light level for the healthcare personnel to perform examination on the patient. The direction of the lens 103c can also be adjusted upward thus bouncing the light off the ceiling, rather than shining directly to the patient, in case indirect lighting is more desirable or when it is necessary to use the light of the light source 102b to enhance the light level for the ambient lighting mode.

The exterior of the fixture 100, including the housing 101 and the lens 103a, 103b, 103c is coated with an anti-bacterial photocatalytic film that contains rhombus-shaped anatase-type titanium dioxide and nano silver. The anti-bacterial photocatalytic film can be activated by either the light of the fixture or ambient light for killing airborne bacteria and viruses that make contact with the anti-bacterial photocatalytic film. In US, the air ventilation requirement for patient room is six air exchanges per hour per room. Such air ventilation provides sufficient air movement in the patient room and could bring airbome bacteria and viruses to the surface of the overbed fixture. With coated with anti-bacterial photocatalytic film, this overbed lighting fixture becomes effectively an infection-control equipment in the patient room, providing continual anti-bacterial/anti-viral protection for the patient.

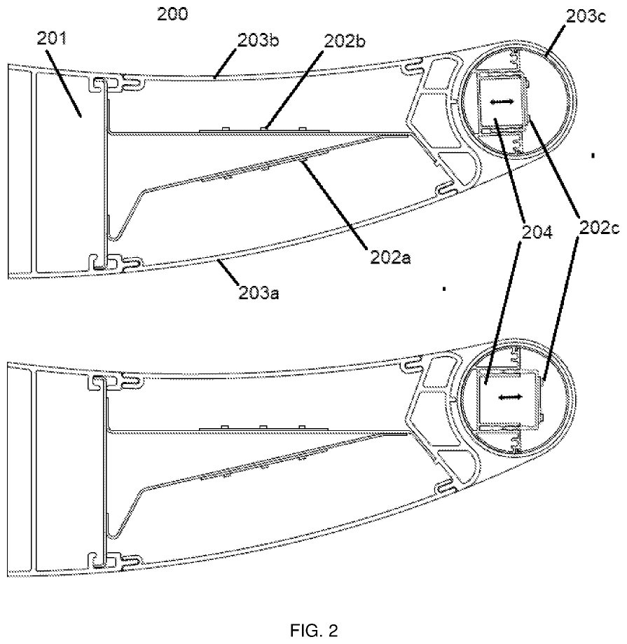

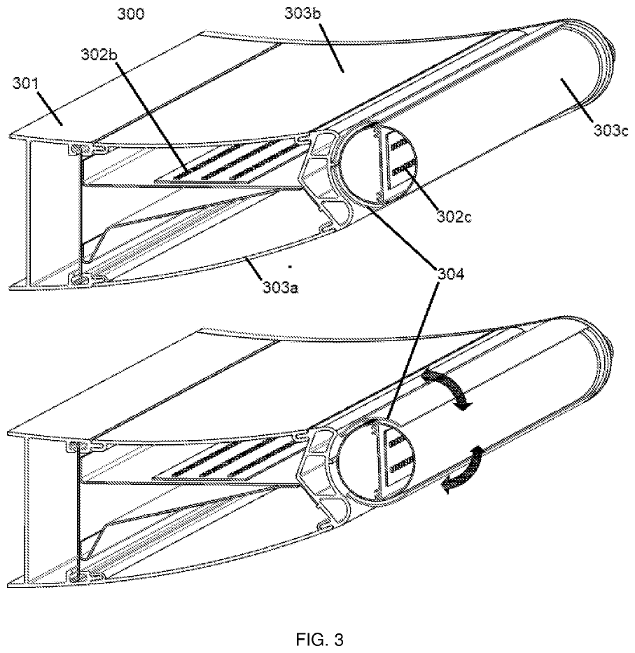

The FIG. 2 is another embodiment of the present disclosure, where the position of the light source 202c is adjustable toward or away from the lens 203c, though a shifting handle 204. When the light source 202c is closer to the lens 203c, the beam angle of light coming out of the lens 203c is wider. When the light source 202c is away from the lens 203c, the beam angle of light coming out of the lens 203c becomes narrower. This feature enables the user to focus or de-focus of the light coming out of the lens 203c as needed.

The FIG. 3 is yet another embodiment of the present disclosure, where a pair of shutter are used for adjusting the beam angle of the light coming out of the lens 303c. To narrow the beam angle, the shutters are closing up on the lens. To avoid the loss of the light inside the lens on a narrow beam angle, the inside surface of the shutters may be coated with a reflective film such that the light of the light source 302c could bounce off the reflecting material and shine through the lens 303c.

### Additional and Alternative Implementation Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

1. An elongated lighting apparatus, comprising:
an elongated housing;
an elongated light source, wherein:
the elongated light source is dispersed inside the elongated housing, and
the elongated light source is coupled with an elongated lens on the housing;
a first mechanism configured to adjust a center direction of a light emitted out of the elongated lens with the center direction of the light being perpendicular to an axis of the elongated lens; and
a second mechanism configured to expand or contract a beam angle of the light emitted out of the elongated lens with the center direction of the light being adjusted by the first mechanism.

2. (canceled)

3. (canceled)

4. (canceled)

5. The elongated lighting apparatus of claim 4, wherein the second mechanism is configured to adjust vertically the beam angle of the light emitted out of the elongated lens is by changing a distance between the elongated lens and the elongated light source.

6. The elongated lighting apparatus of claim 4, wherein the second mechanism is configured to adjust horizontally the beam angle of the light emitted out of the elongated lens, and wherein the second mechanism comprises an elongated shutter that changes an effective width of the elongated lens in a direction perpendicular to the axis of the elongated lens.

7. The elongated lighting apparatus of claim 1, wherein an exterior of the elongated lens or an exterior of the elongated housing, or both, is or are coated with an anti-bacterial photocatalytic film.

8. The elongated lighting apparatus of claim 7, wherein the anti-bacterial photocatalytic film is photocatalytic activated by a light of the elongated light source.

9. The elongated lighting apparatus of claim 7, wherein the anti-bacterial photocatalytic film is photocatalytic activated by ambient light with at least 95% of a spectral power distribution (SPD) in a visible light wavelength range greater than 400 nm.

10. The elongated lighting apparatus of claim 7, wherein a main active ingredient of the anti-bacterial photocatalytic film comprises titanium dioxide (TiO2).

11. The elongated lighting apparatus of claim 10, wherein the main active ingredient comprises rhombus-shaped anatase-type titanium dioxide (TiO2).

12. The elongated lighting apparatus of claim 7, wherein the anti-bacterial photocatalytic film contains at least one other active metal ingredient comprising silver, gold, copper, zinc, nickel, or a combination thereof.

13. The elongated lighting apparatus of claim 7, wherein a main active ingredient of the anti-bacterial photocatalytic film comprises a noble metal nanoparticle comprising gold (Au) or sliver (Ag).
